(19) United States
(12) Patent Application Publication
(10) Pub. No.: US 2015/0242881 A1
(43) Pub. Date: Aug. 27, 2015

(54) METHODS AND SYSTEMS FOR PAYMENT COOPERATIVES THAT LEVERAGE GROUP PRICING FOR PAYMENT PROCESSING AND RELATED SERVICES

(71) Applicant: U.S. Bancorp, National Association, Minneapolis, MN (US)

(72) Inventors: Jacob M. Osborne, Elm Grove, WI (US); Ryan Jewison, Woodbury, MN (US); Justin Corum, Knoxville, TN (US)

(21) Appl. No.: 14/627,638

(22) Filed: Feb. 20, 2015

Related U.S. Application Data
(60) Provisional application No. 61/943,253, filed on Feb. 21, 2014.

(51) Int. Cl. G06Q 30/02; G06Q 50/00

(52) U.S. Cl. CPC G06Q 30/0236; G06Q 50/01

(57) ABSTRACT

An illustrative method according to a set of instructions stored on the memory of a computing device includes receiving, by a processor of the computing device, a request from a merchant device for payment processing services. The merchant device is associated with a first merchant. The method also includes receiving, by the processor, a request from the merchant device to associate with a group of merchants. The method also includes associating, by the processor, the merchant with the group of merchants such that the merchant is considered a part of the group of merchants. The method also includes determining, by the processor, a fee structure for the payment processing services for the merchant. The fee structure is determined based on a threshold met by the group of merchants.

### CROSS-REFERENCE TO RELATED PATENT APPLICATION

This application claims priority to U.S. Provisional Application 61/943,253 filed on Feb. 21, 2014, the entire contents of which are incorporated herein by reference.

### BACKGROUND

Merchants are often involved in commerce selling, buying, and trading different goods and services. In exchange for goods and services, merchants often accept currency as a medium of exchange. Currency may be money banknotes, other paper money, coins, or other forms of physical currency. One example of a physical currency is the United States (US) dollar.

Many merchants accept currency like the US dollar, but make use of electronic or digital currency that has similar properties to physical currency, but can be instantaneously or near instantaneously transferred between a merchant and customer, a merchant and a bank, a customer and the merchant's bank account, etc. The medium of exchange for the goods or services is therefore a digital rather than physical currency. For example, digital currency may be transferred using a variety of mediums such as negotiable instruments such as a check, an e-check, electronic funds transfer, an automated clearinghouse, a debit card, a credit card, a stored value card, a private merchant specific electronic currency (such as reward or loyalty points), wire transfers, direct deposit, instant electronic payment systems (e.g., Bluetooth™ or other near field communication (NFC) device, Paypal™, or the like), electronic bill payment systems, bitcoin transactions, or any other type of digital currency.

Merchants often accept multiple forms of physical and/or digital currency in order to facilitate convenience for customers, incentivizing spending with the merchant. In order to take advantage of certain mediums of exchange, such as credit and debit cards, a merchant may utilize a payment processor to provide payment processing services. Merchants often pay for payment processing services by paying fees. Examples of such fees may be a flat per transaction fee, a percent of the total transaction fee, and/or a periodic (such as per month) fee.

### SUMMARY

An illustrative method according to a set of instructions stored on the memory of a computing device includes receiving, by a processor of the computing device, a request from a merchant device for payment processing services. The merchant device is associated with a first merchant. The method also includes receiving, by the processor, a request from the merchant device to associate with a group of merchants. The method also includes associating, by the processor, the merchant with the group of merchants such that the merchant is considered a part of the group of merchants. The method also includes determining, by the processor, a fee structure for the payment processing services for the merchant. The fee structure is determined based on a threshold met by the group of merchants.

An illustrative non-transitory computer readable medium having instructions stored thereon that, upon execution by a computing device, cause the computing device to perform operations, wherein the instructions include instructions to receive a request from a merchant device for payment processing services. The merchant device is associated with a first merchant. The instructions further include instructions to receive a request from the merchant device to associate with a group of merchants. The instructions further include instructions to associate the merchant with the group of merchants such that the merchant is considered a part of the group of merchants. The instructions further include instructions to determine a fee structure for the payment processing services for the merchant. The fee structure is determined based on a threshold met by the group of merchants.

An illustrative apparatus includes a memory, a processor coupled to the memory, and a first set of instructions stored on the memory and configured to be executed by the processor. The processor is configured to receive a request from a merchant device for payment processing services. The merchant device is associated with a first merchant. The processor is further configured to receive a request from the merchant device to associate with a group of merchants. The processor is further configured to associate the merchant with the group of merchants such that the merchant is considered a part of the group of merchants. The processor is further configured to determine a fee structure for the payment processing services for the merchant. The fee structure is determined based on a threshold met by the group of merchants.

### BRIEF DESCRIPTION OF THE DRAWINGS

Illustrative embodiments will hereafter be described with reference to the accompanying drawings.

FIG. 1 is a block diagram illustrating a first merchant device, server, a second merchant device, a first merchant point-of-sale device, and a second merchant point-of-sale device that may be used in accordance with an illustrative embodiment.

FIG. 2 is a figure representing a user interface illustrating a home screen of a payment cooperative that may be used in accordance with an illustrative embodiment.

FIG. 3 is a figure representing a user interface illustrating an informational page about a payment cooperative that may be used in accordance with an illustrative embodiment.

FIG. 4 is a figure representing a user interface illustrating an informational page about a payment cooperative that may be used in accordance with an illustrative embodiment.

FIG. 5 is a figure representing a user interface illustrating an informational page about a payment cooperative that may be used in accordance with an illustrative embodiment.

FIG. 6 is a figure representing a user interface illustrating instructions on starting a payment cooperative that may be used in accordance with an illustrative embodiment.

FIG. 7 is a figure representing a user interface illustrating a payment cooperative search tool that may be used in accordance with an illustrative embodiment.

FIG. 8 is a figure representing a user interface illustrating a member login page that may be used in accordance with an illustrative embodiment.

FIG. 9 is a figure representing a user interface illustrating a current payment cooperative status that may be used in accordance with an illustrative embodiment.

FIG. 10 is a figure representing a user interface illustrating a member login page that may be used in accordance with an illustrative embodiment.

FIG. 11 is a figure representing a user interface illustrating a member home page that may be used in accordance with an illustrative embodiment.

FIG. 12 is a figure representing a user interface illustrating a member referral page that may be used in accordance with an illustrative embodiment.

FIG. 13 is a figure representing a user interface illustrating a merchant group home page that may be used in accordance with an illustrative embodiment.

FIG. 14 is a figure representing a user interface illustrating a merchant group member page that may be used in accordance with an illustrative embodiment.

FIG. 15 is a flow diagram illustrating a method for joining a merchant group in accordance with an illustrative embodiment.

FIG. 16 is a flow diagram illustrating a method for sending a referral to a merchant in accordance with an illustrative embodiment.

FIG. 17 is a flow diagram illustrating a method for a rewards program in accordance with an illustrative embodiment.

FIG. 18 is a flow diagram illustrating a method for a stored value account in accordance with an illustrative embodiment.

FIG. 19 is a flow diagram illustrating a method for a notification process for a group of merchants in accordance with an illustrative embodiment.

### DETAILED DESCRIPTION

Described herein are illustrative embodiments for methods and systems that provide for payment cooperatives that leverage group pricing for payment processing and related services. According to an illustrative embodiment, a payments cooperative allows merchants/businesses to form groups that allow them to collectively leverage their business to gain benefits for financial services such as payment processing services to get pricing and services often afforded to large scale merchants/businesses. In other words, merchants may group together to get the same discounts, pricing, and/or benefits (or collectively: fee structure) that amounts to a bulk discount, pricing, and/or benefits (fee structure), such that the merchants may access fee structures collectively that individually they would not be able to access.

In an illustrative embodiment, merchants sign up for payment processing services. Such payment processing services may be offered by any type of entity. Just one example of an entity that may offer payment processing services is a financial institution (e.g., bank, credit union, lender, trust company, building society, etc.) that processes payments. Other types of entities may also offer payment processing services. The payment processing services can include services such as processing credit card transactions, debit card transactions, prepaid value card transactions for the merchant, and/or loyalty/rewards programs. When using a payment processing service, a merchant pays fees for the service, normally a per transaction flat fee, a percentage of each transaction fee, a per time period (e.g., per month) fee, interchange fees, downgrade fees, and/or other fees.

In an illustrative embodiment, businesses/merchants will join a group (also referred to herein as a tribe or network) of merchants that have the common goal of reducing their payment processing service fees. The merchants may have a product/service tie to one another (i.e., a group may include businesses that offer services and products for pets as one example), a geographical tie to one another (e.g., merchants in Northern Minnesota; Nashville, Tenn.; the Logan Square neighborhood of Chicago; a particular shopping center), or no ties at all. An advantage of joining a group of merchants, or payments cooperative (coop), for a merchant is that by connecting to other merchants, the fees associated with a payment processing service can be reduced.

A merchant who has joined a payments coop (or group of merchants) can recruit other business owners to join the payments coop, increasing the size of the group or network and further reducing fees associated with the payment processing services. A merchant can then get discounts on the fee structure for recruiting a new business to the payments coop (or group of merchants). For example, the fees may be reduced incrementally for each merchant that joins the group of merchants. In another example, the fees may be reduced whenever the group of merchants meets predetermined numbers. In yet another example, reduction of fees may be tied to a total number of transactions by the group of merchants or a cumulative amount of currency processed in transactions by the group of merchants. In any of these examples (whether the addition of other merchants or increase of transaction totals) getting the fees reduced is the result of meeting a threshold. That is, whenever a fee structure is lowered for a group of merchants, a threshold has been reached, and that threshold can be related to cumulative transactions, amount of currency, number of merchants, etc. These types of thresholds are all related to characteristics of the group of merchants.

Specific merchants may get additional reduced fees as well. For example, if a first merchant refers a second merchant that was not previously a part of a group of merchants, and the second merchant joins the group of merchants, the first may be said to have reached a referral threshold and receive a discount to fees that the other members of the group of merchants do not receive. A referral threshold may also correspond to a certain number of referrals joining the group of merchants before the fees are reduced. In another embodiment, fee reductions may be temporary. In other words, the reduced fees may only apply for a certain amount of time. For example, if a first merchant refers a second merchant and the second merchant joins the group of merchants, the first and/or merchant may receive a discount on the fees for three months (or any other amount of time).

Accordingly, a merchant may get discounts when the merchant's network reaches certain thresholds. Such thresholds may be the number of total businesses in the network, number of new members recruited to the merchant's network, the number of transactions processed by all the merchants in the network, and/or the dollar values of the transactions processed by all the merchants in the network. In general, the more businesses that are in a group/network, the lower the overall payment processing costs are for all members of the group. In one illustrative embodiment, there may also be additional benefits or lowered fees for a merchant who has never been a part of a group of merchants before. In other words, new customers may receive better fees indefinitely or for a limited time after joining a group of merchants. In another embodiment, a referring merchant who gets a merchant who is a new customer to join a group of merchants may also get additional benefit or lowered fees because the merchant has never been a part of a group of merchants before.

Utilizing social media and networking that merchants already possess provides a convenient medium for increasing groups of merchants. For example, if a restaurant owner is on Facebook™, an owner of the restaurant may send a message to a friend restaurant owner about the exciting opportunity to join a group of merchants. Enhanced communication and greatly increased sharing of information through social networks can help groups of merchants grow. The simplicity and convenience of several tools such as social media and mobile computing devices allows for easy connectivity. Furthermore, such mobile devices and social media may be utilized to apply the system and methods as disclosed herein. Since many are connected at all times with the internet and/or a smart phone, the benefits of networking can be exploited.

Accordingly, the systems and methods disclosed herein provide a way to develop networks and groups to take advantage of certain benefits, allowing widespread access to particular services or products at costs which are not always available individually. This is, specifically, the idea and process of inviting and hosting businesses on a virtual venue, website or app that acts as a collective buying agent specific to the payments acquiring/electronic payment acceptance industry. The more business a merchant is connected to, the lower the merchant's individual rate and transactional costs become. This creates an online center for related and formerly unrelated businesses to connect and leverage one another to ultimately achieve a lower cost for payment acquiring/electronic payment acceptance services.

Pricing in the payments acquiring/electronic payment acceptance industry has may be determined by certain variables—size of the business and/or annual credit card processing volume are a few of the most significant. The methods and systems disclosed herein allows businesses to connect and ultimately be perceived as a larger consortium from a payment acquiring pricing perspective. The methods and systems disclosed herein empower businesses/merchants to build their own association to decrease their payments acceptance operating costs.

The methods and systems disclosed herein provides payment product and/or services pricing, merchant retention, and customer retention. Using the methods and systems disclosed herein, businesses/merchants are able to control costs while also providing benefits to their customers. The value to these businesses/merchants: providing tools like shared gift card and shared loyalty programs to grow revenue and gain new customers while continuing to control costs for payment processing services regardless of how large or small the business/merchant might be.

The systems and methods disclosed herein price a business' payment processing rates and transaction fee not based on an individual business' factors (e.g., card processing volume, ticket size, industry type, what specific type of card is accepted, etc.), or put them in one, two, or three boxes of a pricing scheme based on their individual business' factors, but rather based on the amount of other merchants using the payment processing that are linked to this one business/merchant. The systems and methods herein price on the size of the collective group. The systems and methods disclosed herein offer rate and transactional fee reduction as a group becomes larger.

The systems and methods disclosed herein offer pricing based on the power and depth of merchants' collective value with other merchants. The system, sometimes referred to herein as tribe pricing, leverages individuals' and business owners' love of simplicity and eagerness to share solutions. In other words, a merchant owner or representative may use LinkedIn™, Facebook™, Twitter™, YouTube™, word of mouth, etc. to build a network of merchants and then leverage this in the payment acquiring/electronic payment acceptance industry to gain a lower cost of doing business.

The systems and methods disclosed herein also have the ability to leverage the network/group to gain new customers. Merchants will be encouraged to leverage shared gift card and loyalty programs to gain new merchants within the network. A digitally affluent individual or business owner will readily spread the word about the systems and methods disclosed herein. The benefits of the system can cause merchants and/or their representatives to become infectious with their conviction, such that they will tell their family member, their doctor, their pastor, the local pub owner, etc. to sign up for a network they truly believe will be beneficial to all. Such a system offers attractive branding, transparency, simplicity and customer empowerment that merchants desire and would promote to other similarly situated merchants.

The service business of providing payment processing services, may be best considered as payment acquiring, or the process of obtaining merchants who utilize payment processing services. Merchants of all types are challenged may utilize payment processing, including credit, debit, and electronic payments. Such payment methodologies have costs associated with them. Using the systems and methods disclosed herein allow all merchants to control costs by obtaining more competitive pricing through the network development process.

As applied to electronic payment processing or payment solutions or merchant service, the systems and methods disclosed herein provide benefits to the payment processing organization as well. Such benefits may include: staying competitive against commoditization of payment processing while utilizing commoditization, growing market share while maintaining low attrition rates, diversifying product offerings, low risks and costs, and providing new progressive grassroots marketing brand.

In an embodiment used for payment processing, a no-strings attached, no fine-print, contractually-free alternative to a traditional payment processing accounts may be provided. For example, a modular solution set with simplicity and customization may be used, providing one program which is available for all merchants of all sizes and environments. Published pricing may be provided, which might be hypothetically be set at 2.65% rate and $0.20 per transaction for swiped credit card transaction; and such a rate may be reduced if an individual business connected with others. For example, a group of merchants might instead receive a rate of 2.55% because there are now three merchants instead of one. Or the system might price a business interchange fees (IC/A)+20 basis points (bps) (20/100 of a percentage point) and 10 cents/transaction; and as the business chains to other business, the rates may reduce to IC/A+15 bps and $0.05/transaction. An entire enrollment process for merchants may be online, electronic, automated. Merchants might pick from a series of hardware/software and also receive group discounts for this and other payment services/products including but not limited to gift cards/loyalty cards. Other facets of payment processing fees may also be adjusted. For example, fees for swiping cards and/or keying in card information may be adjusted.

In one illustrative embodiment, pricing is not locked in. That is, pricing can move up or down depending on thresholds met by a group of merchants. However, the proposed systems and methods provide margins that may be configured to rarely or never increase (or will be locked in for a predetermined number of years). A reduction in fees can result from referring additional incremental business to the overall network group. For example, the first approved referral might drop the merchant's pricing by 5 bps, the next might drop an additional 2 bps, and the following three referrals drop one additional bps capping the account at 10 bps and a dime. In sum referring 5 additional merchants cuts their margin in half. Reductions can be manual or systemically automated. In another embodiment, a fee structure may such that fees are reduced, but cannot be raised. That is, once a threshold has been passed, at least that fee structure is locked in. Such a fee structure could also be locked in for a predetermined period of time, and thereafter revert to a fee structure that matches the thresholds met by a group of merchants. In another illustrative embodiment, a fee structure may be locked in permanently and not utilize thresholds to change pricing and fee structures. In such an embodiment, a group of merchants may qualify for a particular fee structure contingent on their collective size when they sign up for payment processing services, and that fee structure may be locked in for a set period of time.

Advantageously, such a payment processing approach lends itself well to grassroots, word of mouth marketing. From some perspectives, small merchants or businesses may be particularly motivated or compelled to collectively leverage their respective volumes, and thus decrease costs. Presently existing contracts/retention aids may be used to keep merchants, but may not be utilized with these systems and methods because such a system's price point is difficult to undercut. If one of the merchants leaves a group of merchants, other merchants in the group may see their pricing revert up (maybe 5 bps) and may replenish their merchant network. Accountability and retention arises given a merchant's association to others and the social pressure not to leave the group.

An illustrative embodiment includes a method for generating, identifying, and establishing additional merchant customers. The method includes establishing a network of members via a plurality of referrals. A founder creates a network directed toward obtaining a predetermined benefit. Other members of the network are added via the plurality of referrals, with the first referral coming from the founder. The method further includes determining a desired product/service offering for the network. The method further includes establishing a predetermined pricing structure for the network to be provided by a supplier of the product/service. The pricing structure is dependent the size of the network. The method further includes engaging the members with the supplier and coordinating a business relationship there between based on the predetermined offering. The method further includes adjusting the pricing structure when the size of the network changes a predetermined amount.

The payment processing services and payments coop disclosed herein may provide additional services, such as group specific loyalty and stored value programs. In such an embodiment, a group of merchants may be able to have a customer loyalty program that accumulates rewards based on purchases or engagement only with the merchants in that particular group. Similarly, a group of merchants may offer stored value card programs (e.g., a gift card) where the value stored can be redeemed only with the merchants in that particular group.

Advantageously, the payments coop may make having merchants sign service contracts for payment processing services obsolete. In other words, merchants who are a part of a payments coop will have an incentive to continue using the payments coop and to recruit additional businesses for its network, thus continually decreasing operating costs. As a result, attrition from the payments coop as compared to previous systems may be reduced, even without the use of binding contracts. Another advantage of a payments coop is that the startup costs of getting a payment processing service through the systems and methods disclosed herein can be drastically reduced. Signing up for a payments coop may be done exclusively online, making customer service and/or sales representatives that assist a new merchant obsolete. Additionally, a new merchant may be recruited by a merchant already a member of a payments coop or group of merchants, eliminating the need for a salesperson to locate and pitch potential new merchants to use a payment processing system.

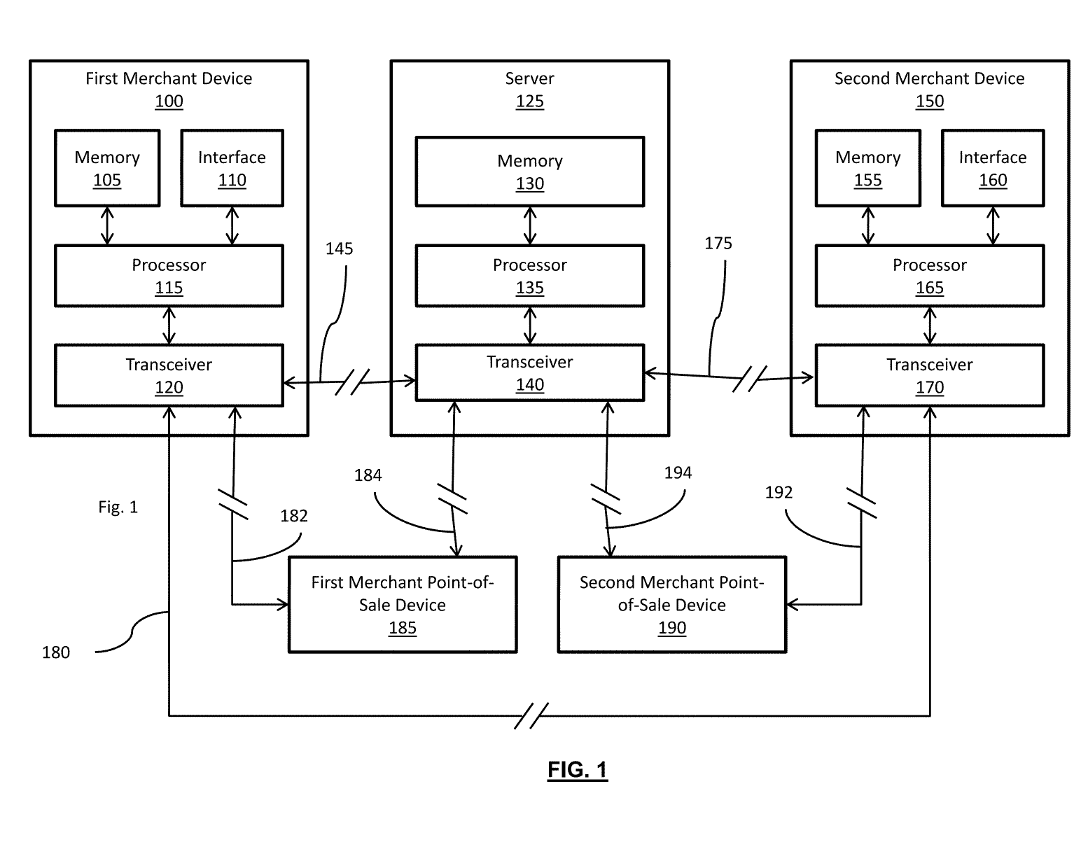

In an illustrative embodiment, a server administrated by the payment processing system provider may receive a request from a merchant device (that is, a device associated with a first merchant) for payment processing services. The merchant device may be a device such as the one disclosed below with respect to FIG. 1, or any other suitable device. The request from the merchant device may also include a request to associate with a group of merchants. Upon receiving the request from the merchant device, the server then associates the merchant device (and accordingly the merchant) with the group of merchants. The server may then generate and process and order to have then necessary information and point-of-sale devices used for the payment processing services sent to the merchant. Further, the server can determine a fee structure for the payment processing services for the merchant and for the group of merchants. As mentioned above, the fee structure associated with the payment processing services is determined based on a threshold met by the group of merchants. In one embodiment, the payment processing service fees are adjusted based on the merchant joining the group because the merchant helped the group meet a particular threshold. In an alternative embodiment, for example where the thresholds are related to transactions, the payment processing service fees are adjusted once the transaction based threshold is met. In other words, if a group of merchants gets a discount for hitting one thousand transactions a week, the fees would not be discounted simply because an additional merchant joined the group, but instead would be discounted once the group hits the transaction threshold (which, however, is helped by having an additional merchant join the group).

Once a fee structure is determined based on a threshold for a group of merchants, the fee structure is applied to the transactions performed by the merchants in the group of merchants. In one embodiment, all of the merchants in the group of merchants have the same fee structure. As described above, not all merchants in a group may always have the exact same fee structure. For example, some merchants may get additional discounts for referrals, high volume of cumulative transactions or currency, etc. The transactions processed by merchants may be through point-of-sale devices. A point-of-sale device may be a specialized device that can communicate with a payment processing server. A point-of-sale device may also be a specialized plug in that works along with a conventional device to perform point-of-sale device functions. For example, a plug in that can work with a smart phone or tablet device may be able to swipe credit and debit cards and send the transaction data to a payment processing server. In another embodiment, a point-of-sale device may be NFC capable to receive credit card or other information for a transaction. A point-of-sale device may be able to visually scan or photograph physical objects such as a check or credit card in order to send transaction information to a payment processing server.

A payment processing server may also receive referral requests from merchant devices that are associated with merchants in a group of merchants. A referral request may include contact information for a second merchant that is not a part of a group of merchants. A server may then generate an invitation to the second merchant, which is sent to the merchant and invites the merchant to associate with the group of merchants. The second merchant may not be a part of any group of merchants, or the second merchant may currently be a part of a different group of merchants. The payment processing server can then send the invitation to the second merchant. The invitation may be sent through e-mail, text message, voice call, instant message, mail, or another communication medium. The invitation may be received at a second merchant device, from which the second merchant may choose to accept the invitation to join the group of merchants and use the payment processing services

The invitation may include various information that helps incentivize and facilitate the second merchant to use the payment processing services and join the group of merchants. For example, the invitation can include an identification of the merchant from which the referral request (and subsequently the invitation) originated. In this way, if the first and second merchants have a relationship outside of the payment processing or payments coop scenario (such as a personal or business relationship), the second merchant may be more likely to consider and accept the invitation. The invitation may also include instructions for the second merchant on how to associate with the group of merchants and use the payment processing services. For example, the invitation may include a link that causes a web page to open on the second merchant's device. The web page may facilitate ordering of the payment processing system and joining the group of merchants for the second merchant.

The invitation may also include an indication of the fee structure that would apply to the payment processing services if the second merchant accepts the invitation for payment processing services and to join the group of merchants. In this way, the second merchant can learn the advantages that will be afforded if the second merchant joins the group of merchants, most notably the fee structure for the payment processing services. Additionally, the information may include other information offered as part of the payment processing services, such as how the fee structure may be reduced in the future, a loyalty/rewards program that may be administered through the payment processing services, and a stored value card system that may be administered through the payment processing systems. All of this information may help entice the second merchant to join the group of merchants and use the payment processing services.

If the second merchant chooses to accept an invitation to join the group of merchants, the payment processing server may receive an affirmative response from the second device of the merchant. Once the accepted invitation is received by the server, the server can associate the second merchant with the group of merchants. The server may also apply a new fee structure to the whole group of merchants, the merchant who sent the referral request, and/or the second merchant who just joined the group of merchants.

After a group of merchants have formed in a payments coop, each of the merchants use the payment processing system to process transactions that occur in the course of their business. In an illustrative embodiment, a payment processing server (which may be the same or different from the server that sets up and manages groups of merchants and payment coops) may receive transaction data from various point-of-sale devices associated with the merchants in a group of merchants. The transaction data may contain various information relating to transactions, such as credit card (or other card) data (also referred to herein as purchaser payment and identity data), loyalty/rewards account number, purchase amount of transaction, merchant identity, and/or any other information associated with a transaction. If something other than a credit card is used for payment, then information regarding that method of payment may also be included. Using the transaction, data the system can process payments for the transaction data and administer a rewards or loyalty program.

In one illustrative embodiment, a rewards/loyalty program tracks the identity of customers that shop at or with the merchants in the group of merchants. In this way, a payments coop or group of merchants have a loyalty rewards program specific to their group of merchants. The system uses the identity of the customers that shop at or with the merchants to reward the customer for their loyalty. For example, the customer may receive discounts when shopping at the merchants if they have reached certainly levels of loyalty (based on total purchases, total money spent, number of transactions completed, frequency of visits to merchants, percent of total merchants in the group of merchants visited, etc.). Rewards may also be granted in the form of free merchandise or services from the group of merchants. Rewards may also be discounts on subsequent transactions. Rewards for loyalty may also be in the form of a private digital currency awarded to the customer, such that the currency can only be redeemed at one of the merchants in the group of merchants. In another embodiment, rewards earned may only be redeemed by a customer at a merchant the customer has not spent money at before. In this way, the merchants may facilitate cross selling between the payments coop/group.

In another illustrative embodiment, the system may be utilized to facilitate a group of merchants specific stored value card. A stored value card may also be referred to as a gift card. In this embodiment, the transaction data received by the payment processing server from various point-of-sale devices associated with the merchants may include a stored value account number. The stored value account number may or may not be associated with a customer's identity and/or a rewards/loyalty account. In some embodiments, a private currency may be used for the stored value account and incorporate rewards granted to a customer associated with the stored value account. In other embodiments, a reward account may not be associated with a stored value account. In another embodiment, the stored value account uses a non-private currency, such as the US dollar. The payment processing server maintains a record of the value of a stored value account. Then, when a transaction is made that includes an indicator of a stored value account, the payment processing system can update the value of a stored value account based on the transaction with the merchant. Such stored value accounts may be sold as gift cards in the merchants in the group of merchants, such that the stored value account is accepted at any one of the merchants as a medium for exchange. Advantageously, merchants in the group of merchants can have access to a stored value account system through the payment processing system.

In an illustrative embodiment, merchants or groups of merchants may qualify for additional reductions of their payment processing fees for utilizing the rewards/loyalty and/or stored value account services. Such reductions may be inherent because the utilization of such services may increase business and transactions at the merchants. In another embodiment, however, reductions in the fee structure for utilizing rewards/loyalty and/or stored value account services may be explicit thresholds that reduce the fee structure for a group of merchants. In other words, utilizing stored value accounts, for example, may automatically trigger a reduction in fees threshold for a group of merchants.

In an illustrative embodiment, a payment processing server that maintains a payments coop of a group of merchants also messages the merchants to update them on the fee status of their group. For example, if the group of merchants meets a threshold and their fee structure is reduced, the merchants are notified by the server. In another example, merchants may leave a group of merchants, and the fee structure may be increased because the group no longer meets a given threshold. Again the server may notify the remaining members in the group of merchants that their fees have been increased. A message can be sent to remaining group members about a departing merchant, even if no increase in fees takes place.

Such messaging about merchants entering/leaving the group and fees being reduced/increased serves an informational purpose, but also helps maintain and build groups. Messaging helps reminds merchants what recruiting new merchants could bring to their business. For example, if a merchant receives a message that a new merchant has joined and their fees are going down, it makes the merchant more likely to remember to market the payments coop in the near future to other potential group members. Messaging regarding leaving members or increased fees may also build in inter-peer accountability and peer pressure to minimize attrition among the group of merchants. In other words, if a group of merchants will all be messaged if a merchant leaves the group, the merchant is less likely to actually leave the group and discontinue using the payment processing services.

In one illustrative embodiment of a payments coop, merchants may be restricted in certain ways from joining and leaving groups of merchants. For example, if a merchant is in a group of merchants, the merchant may be prevented from joining a different group of merchants. In another example, a merchant who is currently in a group of merchants may be prevented from joining a different group of merchants unless that merchant has something in common with the other merchants, such as a geographic proximity, similar type of good or service offered, and/or a similar platform for doing business. An example of a similar platform might be two locally owned retail stores, although (just as one example) one may sell hardware and another sells convenience store items. In another example, a merchant may only join a group of merchants if the merchant has been invited to join by a merchant already in the group of merchants. In this embodiment, merchants may be excited to join once they have been invited, because restricting the system to invite only gives an impression of exclusivity. In another example, a merchant may be permitted to switch groups of merchants a limited number of times. In another embodiment, certain groups of merchants may be capped to a certain number of merchants or some other indicator of size (number of transactions, total money processed in transactions, etc.). In another embodiment, a merchant may be prevented from joining a group of merchants if the merchant has already contracted for payment processing services from the payment processor. The ability of a merchant that is party of a group of merchants to send referral requests may be similarly restricted. For example, a merchant in a group of merchants may be able to send referral requests and invitations to merchants who are not already in a group of merchants and a payments coop. In another embodiment, a merchant already in a group of merchants may be able to send referral requests and invitations to merchants who are not already contracted to receive payment processing services from the payment processor.

A payments coop may also provide a group of merchants an opportunity to network and interact in different ways than they otherwise could. For example, the payments coop server may facilitate communications between merchants in a group of merchants. In this way, the merchants may communicate with each other about recruiting new merchants or their stored value account program or rewards/loyalty program. Such a messaging capability becomes even more powerful where the merchants in a group of merchants can set their own preferences and rules for how stored value accounts and rewards/loyalty services are used and applied in the group of merchants' stores. Any of the characteristics disclosed herein regarding the rewards/loyalty services and/or stored value account services may be customized by the group of merchants. Accordingly, communication between the merchants is valuable so that they can effectively set up such services and run various campaigns utilizing the services. For example, if a merchant wants to focus on getting more customers between 1 PM and 4 PM on weekdays, the merchant may communicate such a desire to the other merchants in his group. If the other merchants agree, they may set up a rewards program that offers additional private currency redeemable with the group of merchants if a customer shops at any of the group of merchants' stores between 1 PM and 4 PM on weekdays. In another embodiment, the rewards promotion may exist for a subset of merchants in the group of merchants. For example, the merchant wanting to increase business between 1-4 PM may run the promotion, while other a different merchant down the street will promote and offer additional awards from 4 PM to 5:30 PM on weekdays. In such a way, merchants may coordinate how to best market and reward customers. In the present example, the rewards program set up by the merchants encourages a customer to visit both merchant's shops in sequence to increase overall business for both merchants.

Once a portfolio or collection of businesses/merchants has grown and matured, a large group of potential candidates exists for additional revenue for the payments processing entity. Additional features may be added to the system, including blogs, message boards, industry info, etc., which may all help increase engagement of the merchants on the payments coop network. Such a network can develop into an online community. Increased online traffic can create valuable advertising/vendor revenue streams for the administrator of the network as well.

The systems and methods disclosed herein ultimately provide marketing tools, open/closed looped gift, check guarantee/direct deposit, payroll supplements, prepaid cards, robust reporting, risk management tools, point-of-sale delivery and integration, dial/IP hardware, etc. The systems and methods disclosed herein empower businesses/merchants to control and impact payment acceptance costs and rebrands payment processing as attractive and useful.

FIG. 1 is a block diagram illustrating a first merchant device 100, server 125, a second merchant device 150, a first merchant point-of-sale device 185, and a second merchant point-of-sale device 190 that may be used in accordance with an illustrative embodiment. In alternative embodiments, fewer, additional, and/or different components may be used to practice the disclosed embodiments. The first merchant device 100 includes a processor 115 that is coupled to a memory 105. The processor 115 can store and recall data and applications in the memory 105. The processor 115 can execute sets of instructions stored on the memory. In one example, a set of instructions may be a mobile application (app). In another example, the set of instructions may be an internet browser. The processor 115 may also display objects, applications, data, etc. on an interface 110. The processor 115 is also coupled to a transceiver 120. With this configuration, the processor 115, and subsequently the first merchant device 100, can communicate with other devices, such as the server 125 through a connection 145, the second merchant device through a connection 180, or the first merchant point-of-sale device 185 through a connection 182.

The server 125 includes a processor 135 that is coupled to a memory 130. The processor 135 can store and recall data and applications in the memory 130. The processor 135 is also coupled to a transceiver 140. With this configuration, the processor 135, and subsequently the server 125, can communicate with other devices, such as the first merchant device 100 through the connection 145, the second merchant device 150 through a connection 175, the first merchant point-of-sale device 185 through a connection 184, or the second merchant point-of-sale device 190 through a connection 194.

The second merchant device 150 includes a processor 165 that is coupled to a memory 155. The processor 165 can store and recall data and applications in the memory 155. The processor 165 can execute sets of instructions stored on the memory. In one example, a set of instructions may be web browser that displays and/or executes a webpage. In another example, a set of instructions may be a software application such as a mobile app. The processor 165 may also display objects, applications, data, etc. on an interface 160. The processor 165 is also coupled to a transceiver 170. With this configuration, the processor 165, and subsequently the second merchant device 150, can communicate with other devices, such as the server 125 through the connection 175, the first merchant device 100 through the connection 180, or the second merchant point-of-sale device 190 through a connection 192.

The first merchant point-of-sale device 185 and the second merchant point-of-sale device 190 may be used to complete transactions by the merchants. Such devices help a customer make a payment to a merchant in exchange for goods and services. Although not shown here, point-of-sale devices may components like a server or other merchant device. For example, point-of-sale devices can be equipped with processors, display interfaces, memory, and transceivers.

Illustrative point-of-sale devices may be used to administer or apply various aspects of the systems and methods disclosed herein. For example, fee structures determined at the server may be applied to transactions completed using point-of-sale devices. Discounts related to the payment processing services, such as discounts related to a rewards/loyalty program as disclosed herein, may be applied to purchases made at a point-of-sale device. Stored value accounts as disclosed herein may be used to purchase goods or services at a point-of-sale device.

Illustrative point-of-sale devices may include specialized hardware and/or software. For example, point-of-sale devices may utilize weighing scales, scanners, conveyor belts, customer display screen, employee display screen, signature capture device, card readers, batteries, wireless headsets, wireless transceivers, tactile keypads, near field communication (NFC) capable transceivers, electronic and/or manual cash registers, electronic funds transfer point-of-sale terminals (EFTPOS), touch screens, printers, and software to utilize these different types of hardware. Specialized software may also be used by point-of-sale devices such as software to help customers customize an order, product, or service. Specialized software may also be used at point-of-sale devices to manage inventory, track financials, manage reservations, print receipts, perform customer relationship management functions, support tipping and cash back functions for customers, etc. Some point-of-sale devices may be other types of devices like a smart phone or tablet computer that uses software to act as a point-of-sale device. Information utilized by a point-of-sale device may be stored on the point-of-sale device, or may be stored on other storage, such as servers, internet cloud storage, etc. If a point-of-sale device is a non-specialized hardware, it may utilize specialized hardware plug-ins to allow it to perform various functions, such as reading credit and/or debit card information.

In just one illustrative embodiment, first merchant device 100 may be a smart phone, Oand the second merchant device 150 may be a tablet computer. In such an embodiment, the first merchant using the smart phone may found a payments coop. Such founding and registering for the payment processing services can be accomplished through communications with the server 125 as disclosed herein. The merchant may then submit a referral request to the server 125 using the smart phone. The server 125 may then send an invitation to join the payments coop to the second merchant, which the second merchant may receive on her tablet computer. In an alternative embodiment, the first merchant may send an invitation and/or referral request to the second merchant through a social network, e-mail system, instant messaging service, short message service (SMS) texting, or any other medium of communication. Such an invitation and/or referral request may be communicated directly to the second merchant through the connection 180 rather than passing through the server 125. Irrespective of how the second merchant receives an invitation/referral request, the invitation will include instructions for how to communicate with the server 125 in order to join the payments coop and register for payment processing services. The point-of-sale devices may be owned by the merchants before joining the payments coop, or may be sent to the merchants once they join the coop (or in the case of a plug in, the plug in may be sent once the merchants join the coop). Here, the merchant devices are capable of communication with the point-of-sale devices. In other embodiments, the merchant devices may not communicate with the point-of-sale devices, but may still indirectly communicate with the point-of-sale devices through the server 125.

The configuration of the first merchant device 100, the server 125, the second merchant device 150, and the point-of-sale devices in FIG. 1 is merely one physical system on which the embodiments disclosed herein may be executed. Other configurations of the devices shown may exist to practice the disclosed embodiments. Further, configurations of additional or fewer devices than the ones shown in FIG. 1 may exist to practice the disclosed embodiments. Additionally, the devices shown in FIG. 1 may be combined to allow for fewer devices or separated where more than the devices shown exist in a system. For example, the first merchant device 100 may also function as the first merchant point-of-sale device 185.

The devices shown in the illustrative embodiment may be utilized in various ways. For example, the connections 145, 175, 180, 182, 184, 192, and 194 may be varied. The connections 145, 175, 180, 182, 184, 192, and 194 may be a hard wired connection. A hard wired connection may involve connecting the devices through a USB (universal serial bus) port, serial port, parallel port, or other type of wired connection that can facilitate the transfer of data and information between a processor of a device and a second processor of a second device, such as between the first merchant device 100 and the server 125. In another embodiment, the connections 145, 175, 180, 182, 184, 192, and 194 may be a dock where one device may plug into another device. While plugged into a dock, the device may also have its batteries charged or otherwise be serviced. In other embodiments, the connections 145, 175, 180, 182, 184, 192, and 194 may be a wireless connection. Such a connection may take the form of any sort of wireless connection, including but not limited to Bluetooth™ connectivity, Wi-Fi connectivity, or another wireless protocol. Other possible modes of wireless communication may include near-field communications, such as passive radio-frequency identification (RFID) and active RFID technologies. RFID and similar near-field communications may allow the various devices to communicate in short range when they are placed proximate to one another. In an embodiment using one illustrative form of near field communication, two devices may or may not physically (or very nearly) come into contact, and one or both of the devices may sense various data such as acceleration, position, orientation, velocity, change in velocity, IP address, and other sensor data. The system can then use the various sensor data to confirm a transmission of data over the internet between the two devices. In yet another embodiment, the devices may connect through an internet (or other network) connection. That is, the connections 145, 175, 180, 182, 184, 192, and 194 represent several different computing devices and network components that allow the various devices to communicate through the internet, either through a hard-wired or wireless connection. The connections 145, 175, 180, 182, 184, 192, and 194 may also be a combination of several modes of connection.

To operate different embodiments of the system or programs disclosed herein, the various devices may communicate in different ways. For example, the first merchant device 100 may download various software applications from the internet. For example, a web browser of specific app may be used in accordance with illustrative embodiments disclosed herein. In one embodiment, the devices may access various aspects of the disclosed embodiments and interfaces through a web browser. Such apps and/or browsers may allow the various devices in FIG. 1 to perform some or all of the processes and functions described herein. Additionally, the embodiments disclosed herein are not limited to being performed only on the disclosed devices in FIG. 1. Many various combinations of computing devices may execute the methods and systems disclosed herein. Examples of such computing devices may include desktop computers, cloud servers, smart phones, personal computers, servers, laptop computers, tablets, blackberries, RFID enabled devices, wearable electronic devices, or any combinations of such devices or similar devices.

In one embodiment, a download of an app to the first merchant device 100 involves the processor 115 receiving data through the transceiver 120 through the internet and from the server 125. The processor 115 may store the app in the memory 105. The processor 115 can then execute the app at any time, including at a time specified by a user through the interface 110. In another embodiment, some aspects of a program or app may not be downloaded. For example, the program or app may be an application that accesses additional data or resources located in the server 125. In another example, the program may be an internet-based application, where the program is executed by a web browser and stored almost exclusively in the server 125, such as functionalities involving a web browser where generally only temporary information and/or configuration information like cookies are stored on the merchant device itself.

In yet another embodiment, once downloaded to a device, a program or app may operate in part without communication with the server 125. In such an embodiment, the merchant device may access or communicate with the server 125 only when needed. For example, an intermittent connection 145 may exist between the server 125 and the first merchant device 100. Where an intermittent connection exists, the first merchant device 100 may only communicate data to or receive data from the server 125 occasionally.

The configuration of the various devices in FIG. 1 is merely one example of a physical system on which the embodiments disclosed herein may be practiced. Other configurations of the devices shown may exist to practice the disclosed embodiments. Further, configurations of additional or fewer devices than the ones shown in FIG. 1 may exist to practice the disclosed embodiments. Additionally, the devices shown in FIG. 1 may be combined to allow for fewer devices or separated where more than the two devices shown exist in a system.

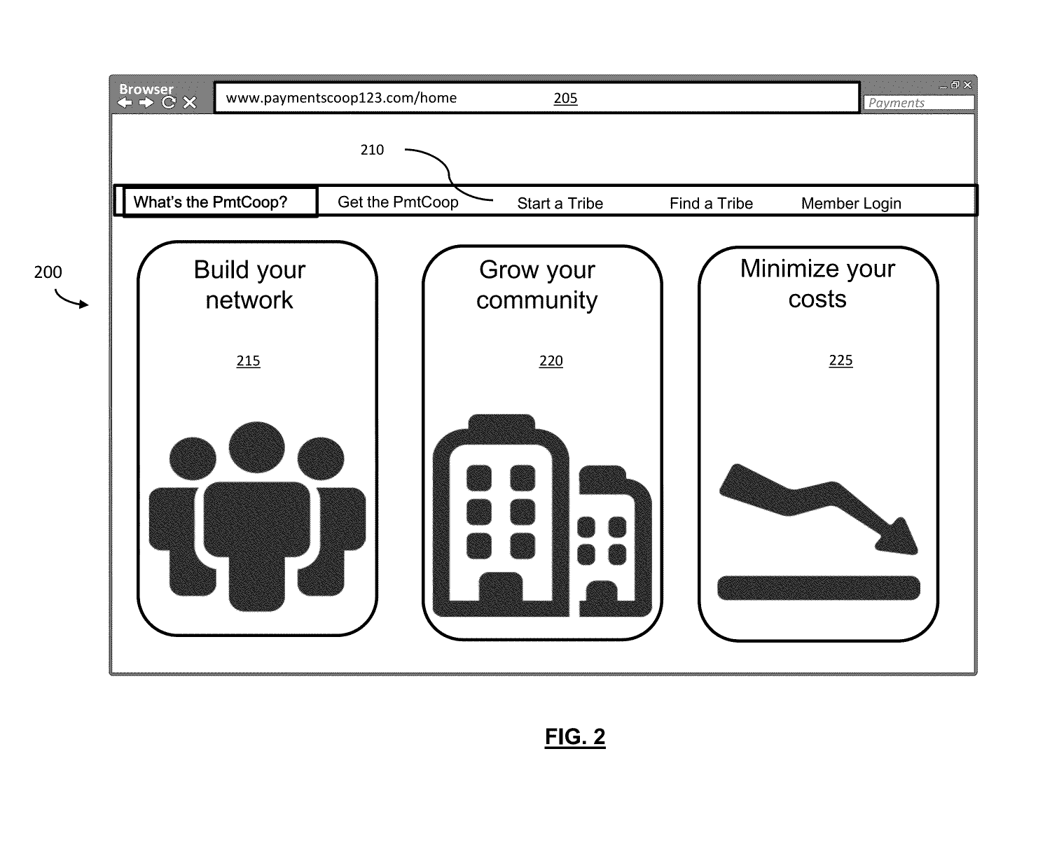

FIG. 2 is a figure representing a user interface 200 illustrating a home screen of a payment cooperative that may be used in accordance with an illustrative embodiment. In alternative embodiments, fewer, additional, and/or different components may be displayed on the user interface. FIG. 2 outlines an overall process contemplated, where a network of organizations or businesses/merchants is created, the network (i.e. community) is further grown, and costs are subsequently minimized due to group purchasing/buying concepts as it relates to the payments acquiring/electronic payment acceptance industry.

The user interface 200 includes information about the payments coop as well as links to further information about the payments coop. It also includes links that allow a user to navigate through signing up for payment processing services, joining a group of merchants, and accessing features, methods, and systems as disclosed herein.

The user interface 200 shows a browser with a universal resource identifier (URI) 205. The URI 205 is a web address that directs a user to the user interface 200. The user interface 200 also includes a navigation bar 210, and buttons 215, 220, and 225. The navigation bar 210 includes buttons that can be selected to navigate to other various web pages, as discussed below. These buttons include a “What's the PmtCoop?” button, a “Get the PmtCoop” button, a “Start a Tribe” button, a “Find a Tribe” button, and a “Member Login” button. In this example, the “What's the PmtCoop?” button is selected to show the other information on the user interface 200. This page may also serve as a home page for the website. That is, a user accessing the payments coop website may be directed to the user interface 200 by default, unless a more specific web address is used. Similarly, if the user was accessing a system using a payment coop specific app, this may be the starting screen of the app. The button 215 can be selected in order to learn more about building a network or group of merchants. The button 220 can be selected in order to learn more about growing a community through the payments coop. The button 225 can be selected to learn about the financial benefits of joining a group of merchants in a payments coop.

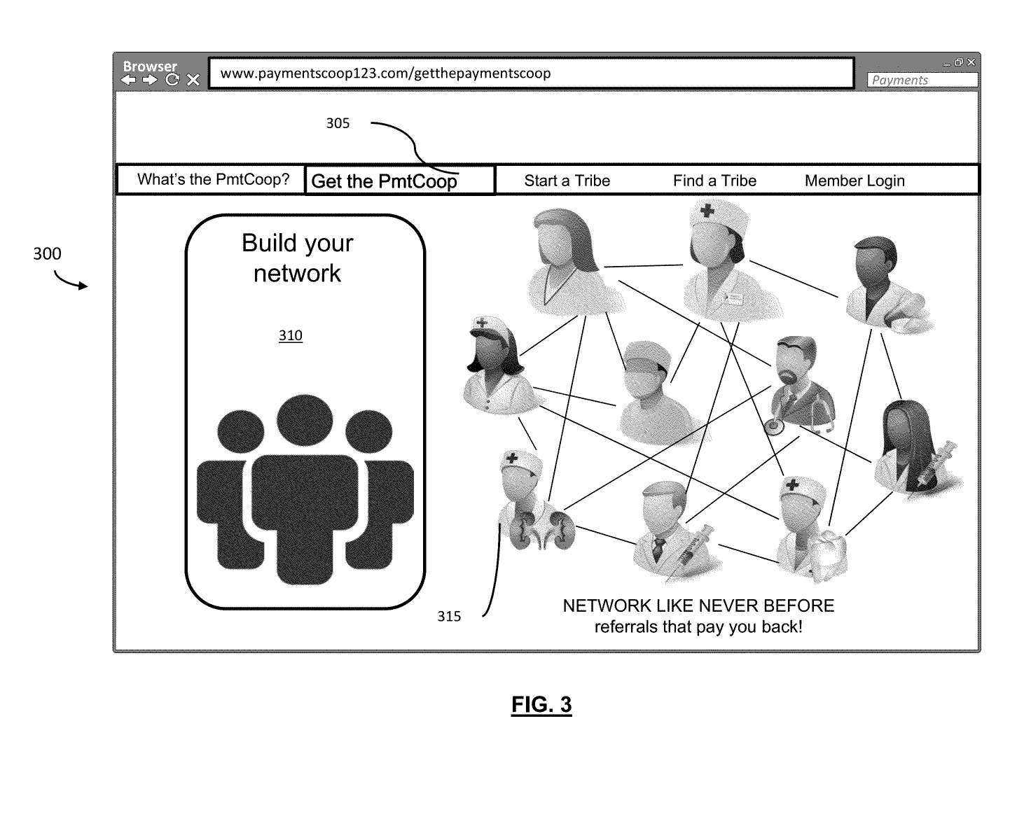

FIG. 3 is a figure representing a user interface 300 illustrating an informational page about a payment cooperative that may be used in accordance with an illustrative embodiment. In alternative embodiments, fewer, additional, and/or different components may be displayed on the user interface. FIG. 2 generally shows the concept of network formation. Networking may take many forms, including the use of existing social media platforms as disclosed herein. A social media tool within the system may also be utilized.

The user interface 300 includes a selected button 305, a theme pane 310, and a graphic 315. The selected button 305 is the “Get the PmtCoop” button. The theme pane 310 shows which part of the home screen the user has navigated to. The graphic 315 shows an example network or group of merchants. Here, a network of doctors is shown to demonstrate how merchants that offer similar goods or services may group together in a network to lower their collective payment processing costs and take advantage of other benefits as disclosed herein.

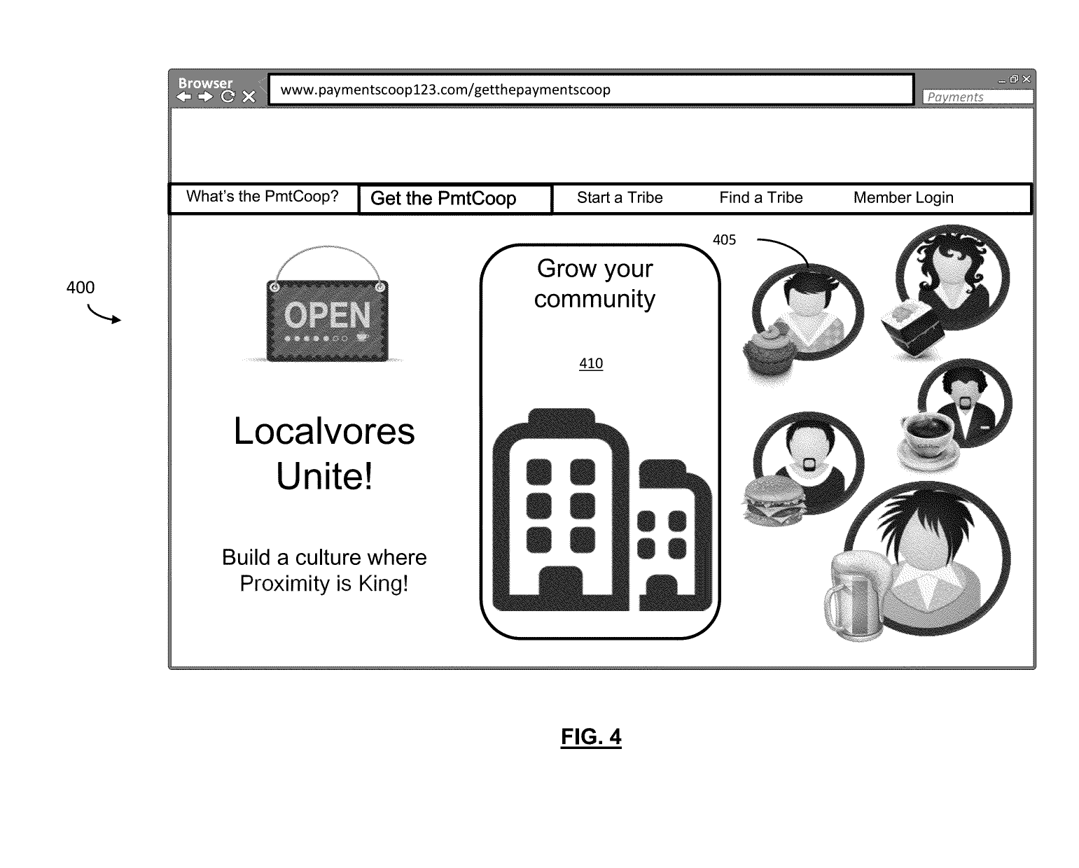

FIG. 4 is a figure representing a user interface 400 illustrating an informational page about a payment cooperative that may be used in accordance with an illustrative embodiment. In alternative embodiments, fewer, additional, and/or different components may be displayed on the user interface. Network growth is generally illustrated in FIG. 4. Existing social media tools can be used to accommodate this process. Networks could take many different forms. For example, referrals may be generally encouraged, so that potential benefits of the networking can be widely shared. Alternatively, the network could be inherently limited depending upon the services contemplated. For example, the above mentioned payment processing example would not be appropriate for the general public.

The user interface 400 includes a graphic 405 and a theme pane 410. The graphic 400 shows an example of how local merchants all in the food service industry may group together to advantageously form a network. The theme pane 410 shows which part of the home screen the user has navigated to.

FIG. 5 is a figure representing a user interface 500 illustrating an informational page about a payment cooperative that may be used in accordance with an illustrative embodiment. In alternative embodiments, fewer, additional, and/or different components may be displayed on the user interface. FIG. 5 generally shows that cost savings and cost controls is part of joining the payments coop. By using the functionalities described herein, a user can better understand the pricing structures for payment processing, and can therefore achieve greater networking, savings, etc. through that transparent pricing and by describing in detail the cost savings and how those savings can be realized.

The user interface includes a table 505 and a theme pane 510. The table 505, although not actually shown here, would be a grid or spreadsheet type table that demonstrates to a user how increasing the network causes the fee structures to be reduced. The theme pane 510 shows which part of the home screen the user has navigated to.

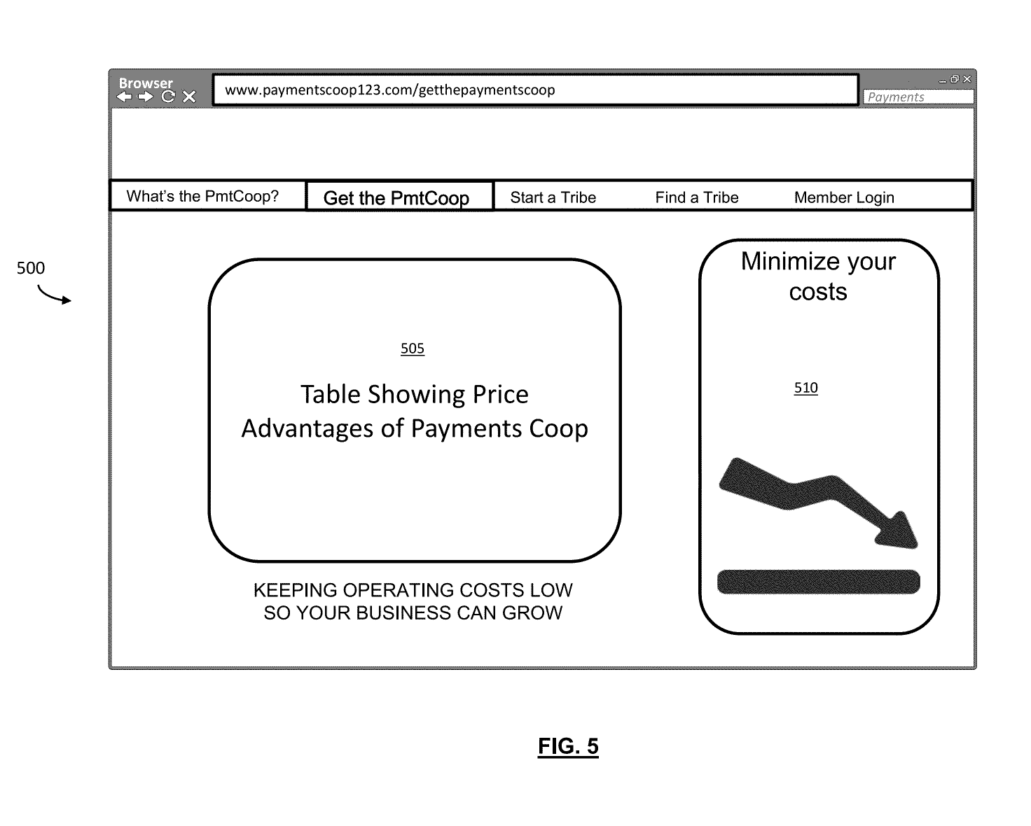

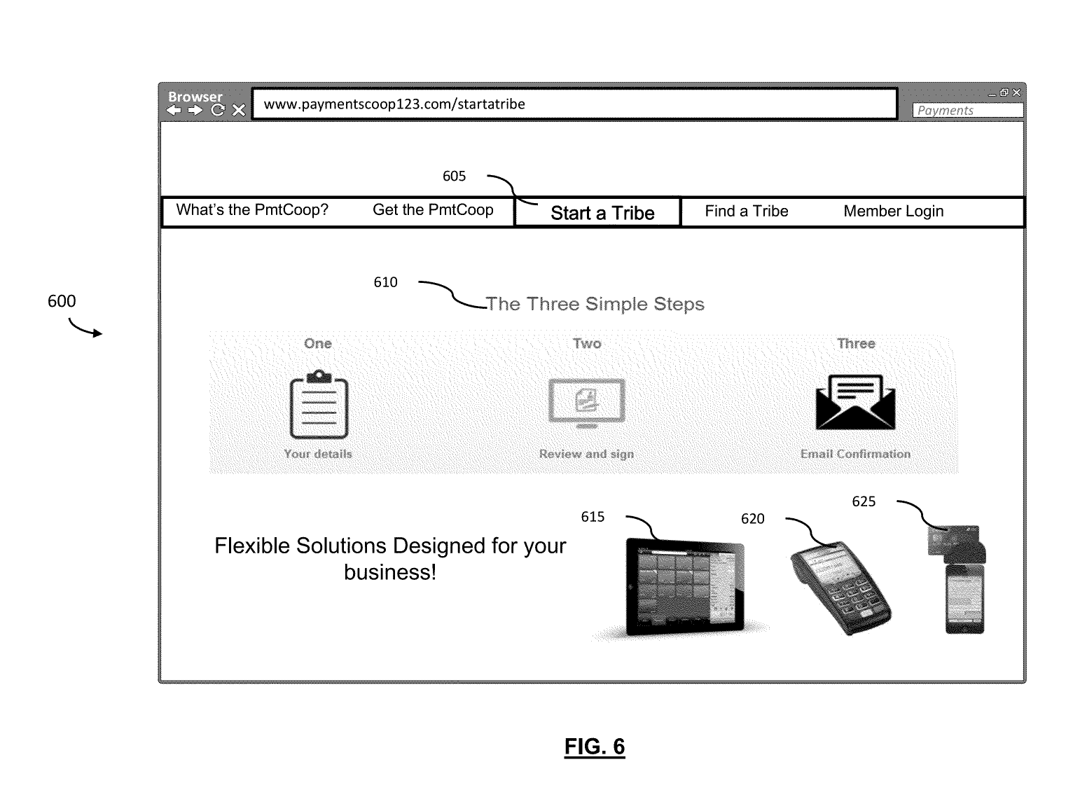

FIG. 6 is a figure representing a user interface 600 illustrating instructions on starting a payment cooperative that may be used in accordance with an illustrative embodiment. In alternative embodiments, fewer, additional, and/or different components may be displayed on the user interface. In FIG. 6, the general steps of network formation are outlined (i.e., starting a tribe/network/group).

The user interface 600 shows a selected button 605, a three step signup outline 610, and possible point-of-sale devices 615, 620, and 625. The selected button 605 here is the “Start a Tribe” button. The three step signup outline 610 shows that user may sign up for payment processing services and start a group of merchants by entering important details about the merchant, reviewing and signing terms and conditions, and confirming the information through e-mail (such as activating a link in an e-mail automatically generated by the system). If a merchant is joining a group as opposed to founding one, similar steps may be followed.

The user interface 600 also shows various point-of-sale devices 615, 620, and 625 that may be utilized if a merchant signs up to use the payment processing services. The various devices may be used as the sole point-of-sale devices by a merchant, or the devices may be used in combination for varying purposes by a merchant. For example, the device 615 is a tablet computer and may function with specialized software to manage a merchant's payment processing services including their network/group, stored value accounts, and loyalty/rewards programs. The device 620 may be used in connection with a cash register to swipe credit cards, debit cards, stored value cards, and the like. The device 625 may be a smart phone with a plugin that can also swipe varying cards. A smart phone may also have NFC capabilities that let it receive information from contactless credit cards and the like.

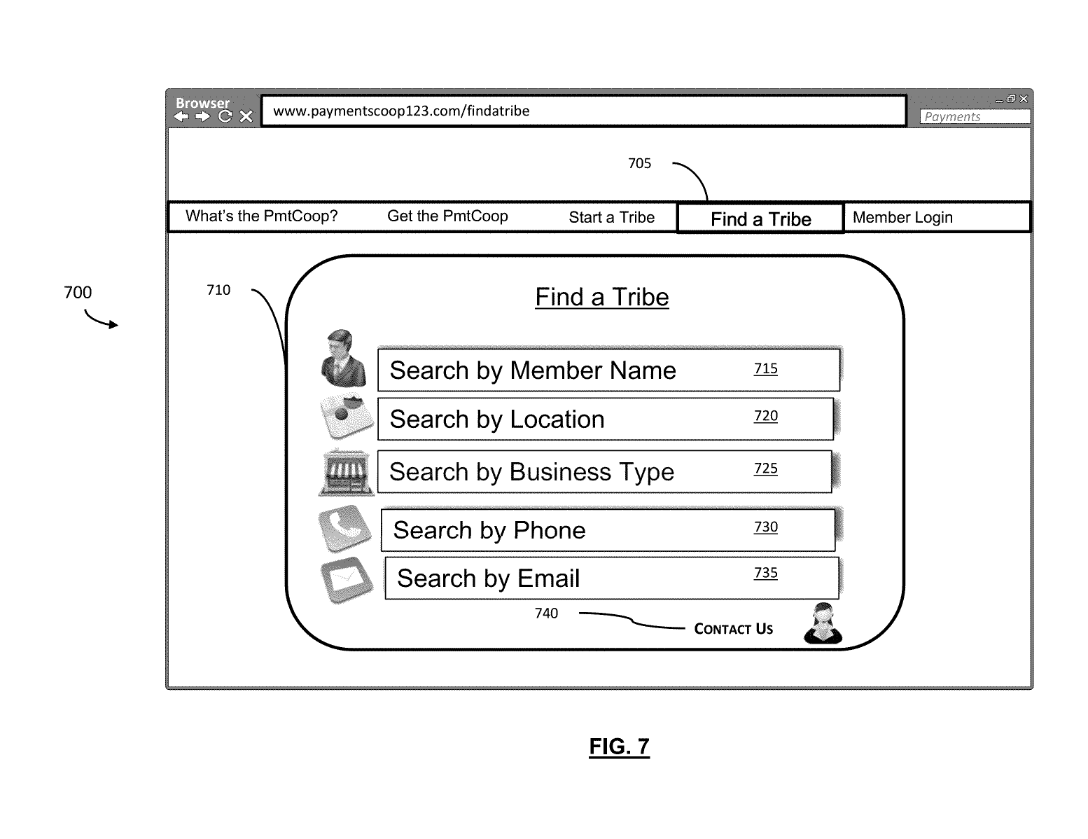

FIG. 7 is a figure representing a user interface 700 illustrating a payment cooperative search tool that may be used in accordance with an illustrative embodiment. In alternative embodiments, fewer, additional, and/or different components may be displayed on the user interface. FIG. 7 shows an interface that may help a merchant find a tribe/network/group to join.

The user interface 700 includes a selected button 705; a search interface 710; search fields 715, 720, 725, 730, and 735; and a contact us button 740. The selected button 705 indicates that the “Find a Tribe” button has been selected. The search interface 710 includes the various fields that a user may input to look for a network/tribe/group. For example, a user may search for tribes by member or merchant name (field 715), geographic location, region, or proximity to a location (field 720), business type (725), phone number (730), and/or e-mail address (735). The fields 730 and 735 may easily facilitate referrals and invitations. For example, if one merchant sends another an invitation, the second merchant may only need a link to the payments coop website and the phone number of the inviting merchant in order to locate and join a group of merchants.

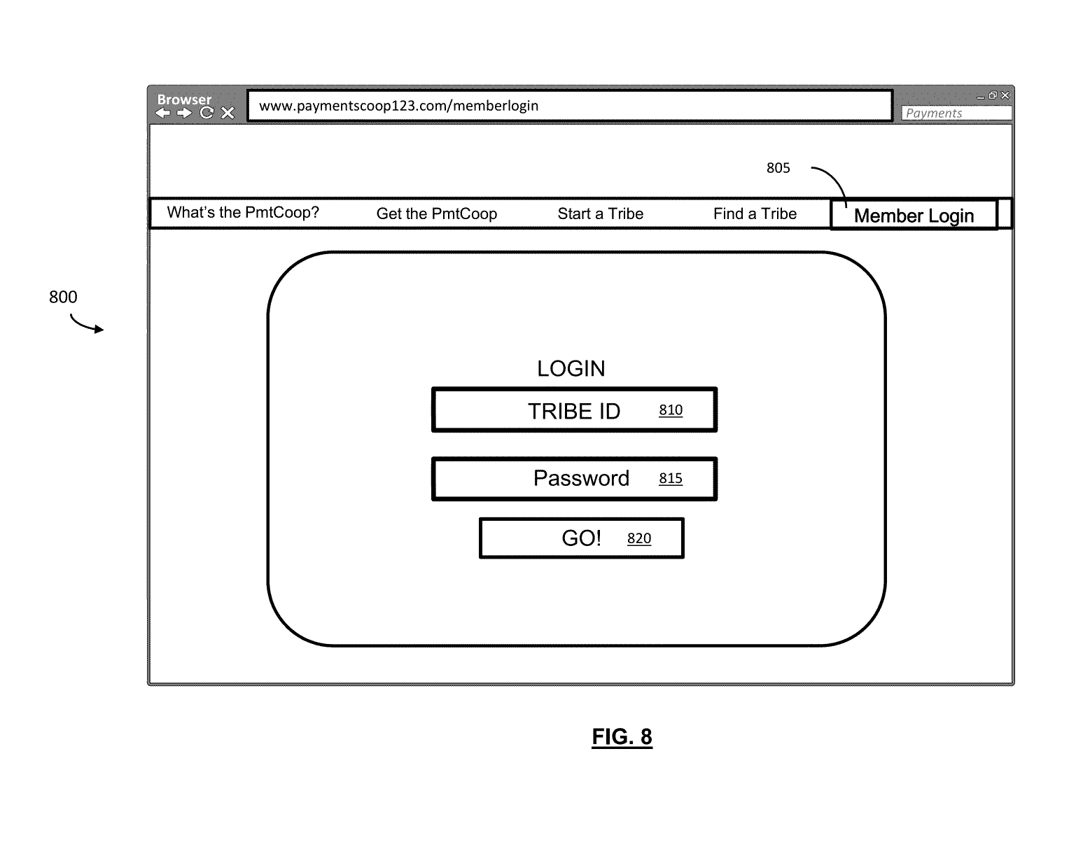

FIG. 8 is a figure representing a user interface 800 illustrating a member login page that may be used in accordance with an illustrative embodiment. In alternative embodiments, fewer, additional, and/or different components may be displayed on the user interface. FIG. 8 shows a member sign-in screen, which can accommodate a member desiring to access the group, or possibly other features of the system like stored value accounts or loyalty/rewards programs. Once signed in, a network status page is provided for users to make referrals, to see other members, and to review the status of the group.

The user interface 800 shows a selected button 805, an ID entry 810, a password entry 815, and a submit button 820. The selection button 805 here is the “Member Login” button. The ID entry 810 allows a user to enter their unique user name or other identifying information that may be established when a merchant joins a payments coop. The password entry 815 allows a user to enter a secret password that can be set up when the merchant joins the payments coop. After entering an ID and password, the user can select the submit button 820. Then the system can determine if the ID and password match a member merchant. If so, the user can access information related to that member merchant.

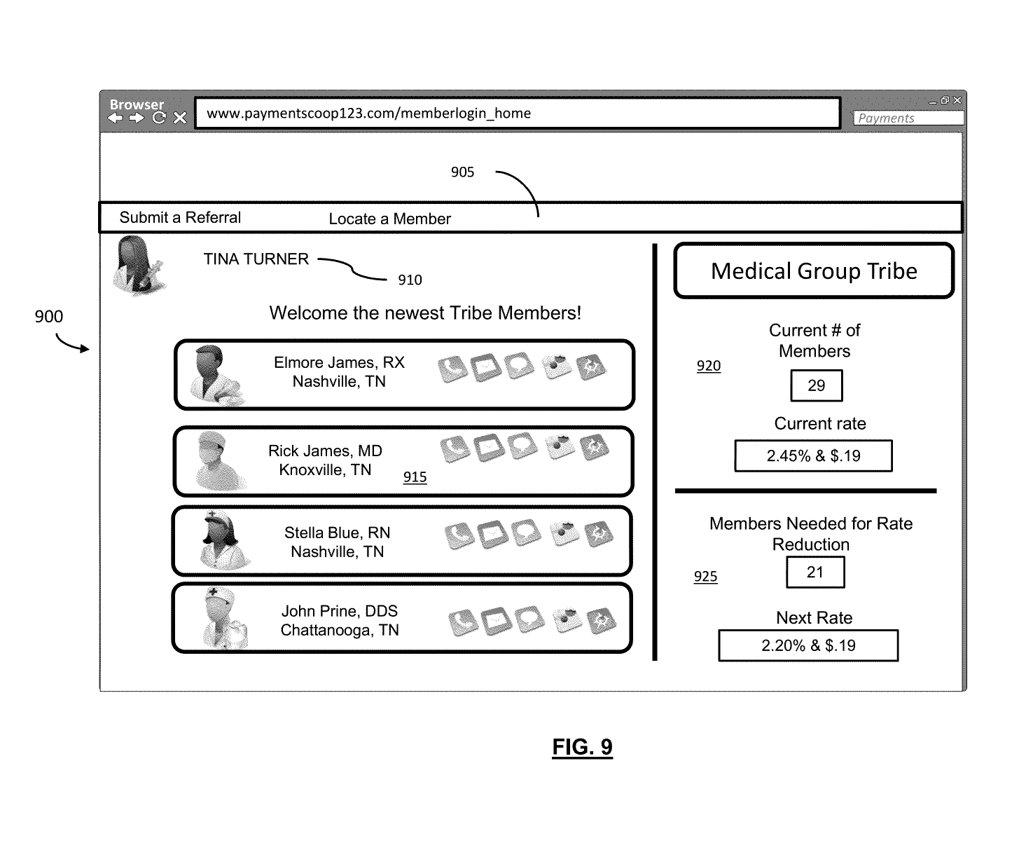

FIG. 9 is a figure representing a user interface 900 illustrating a current payment cooperative status that may be used in accordance with an illustrative embodiment. In alternative embodiments, fewer, additional, and/or different components may be displayed on the user interface. Here, a user interface 900 is shown that may be displayed after a user successfully enters an ID and password as discussed above with respect to FIG. 8.

The user interface 900 shows a navigation pane 905, a member merchant name 910, a group member merchant 915, current fee structure 920, and next threshold fee structure 925. The navigation pane 905 includes a “Submit a Referral” button and a “Locate a Member” button. The “Submit a Referral” button may be selected in order to navigate to a webpage that facilitates submitting a referral request and sending an invitation to join a group of merchants. The “Locate a Member” button can be selected to navigate to a page where a user can search for a member that is already in the user's group of merchants. In an alternative embodiment, the user may be able to search for other merchants that have already joined a different group of merchants.

The member merchant name 920, here Tina Turner, is shown to identify the member merchant that has logged in. The user interface 900 also shows various other members of the group, including the merchant 915, Rick James. The merchant 915 also allows the user to select various buttons to interact with the merchant, such as call, e-mail, or text the merchant, locate the merchant, and visit the merchant's website. The current fee structure 920 shows how many members are currently in the group and what fee structure applies to the group. The next threshold fee structure 925 shows how many more members the group must get to qualify for the fee reduction. It also shows what rate would apply if that number of merchants was added. This can incentivize the current members to grow the group.

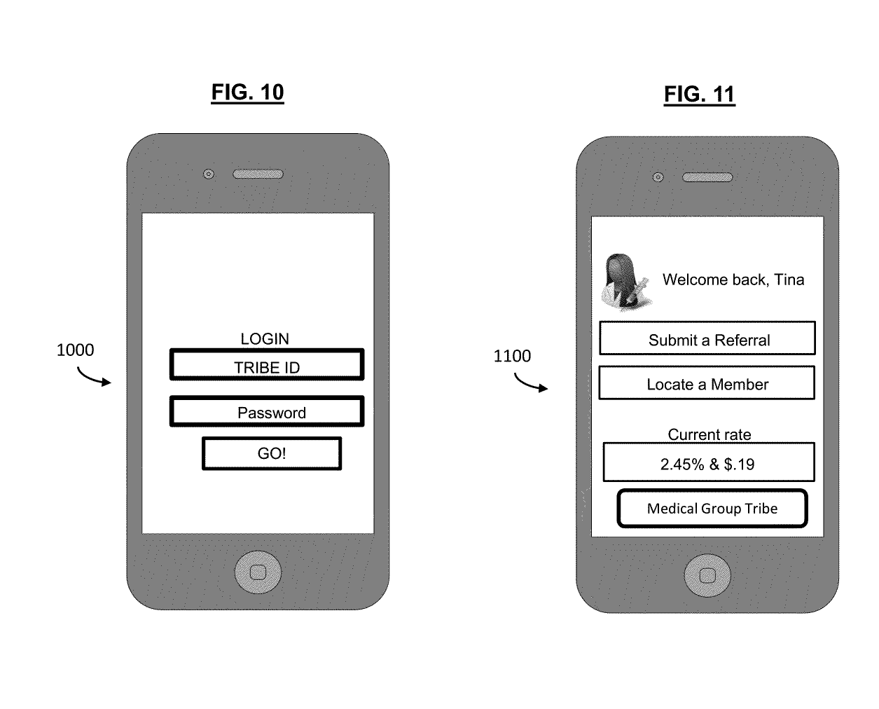

FIG. 10 is a figure representing a user interface 1000 illustrating a member login page that may be used in accordance with an illustrative embodiment. In alternative embodiments, fewer, additional, and/or different components may be displayed on the user interface. The user interface 1000 shows a login screen, similar to FIG. 8 discussed above, but on a mobile device. This may be accessed through a web browser or a mobile app.

FIG. 11 is a figure representing a user interface 1100 illustrating a member home page that may be used in accordance with an illustrative embodiment. In alternative embodiments, fewer, additional, and/or different components may be displayed on the user interface. The user interface 1100 shows a user interface similar to aspects of FIG. 10 above, except on a mobile device. This may be accessed through a web browser or a mobile app.

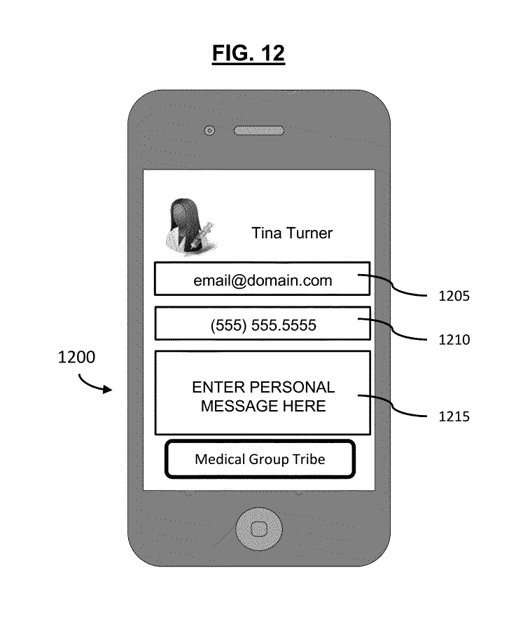

FIG. 12 is a figure representing a user interface 1200 illustrating a member referral page that may be used in accordance with an illustrative embodiment. The user interface 1200 allows a referral to be sent to a potential member merchant. For example, the merchant may enter a potential member merchant's e-mail into entry 1205, and enter the potential member merchant's phone number into entry 1210. The merchant may also type a message to the potential member merchant in entry 1215.

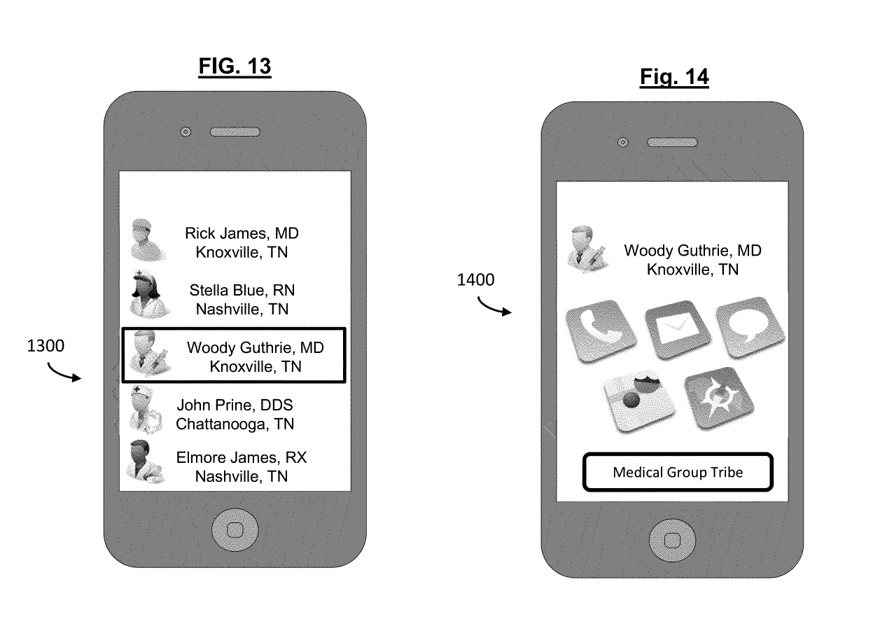

FIG. 13 is a figure representing a user interface 1300 illustrating a merchant group home page that may be used in accordance with an illustrative embodiment. In alternative embodiments, fewer, additional, and/or different components may be displayed on the user interface. FIG. 14 is a figure representing a user interface 1400 illustrating a merchant group member page that may be used in accordance with an illustrative embodiment. In alternative embodiments, fewer, additional, and/or different components may be displayed on the user interface.

The user interfaces 1300 and 1400 show similar content to FIG. 9 discussed above, except split across two interfaces to better facilitate the smaller screen on a mobile device. Here, when a user would like to select a particular member on the interface 1300, such as Woody Guthrie, more information about the user is shown on the interface 1400. In other words, selecting a user from the user interface 1300 navigates a user to the user interface 1400.

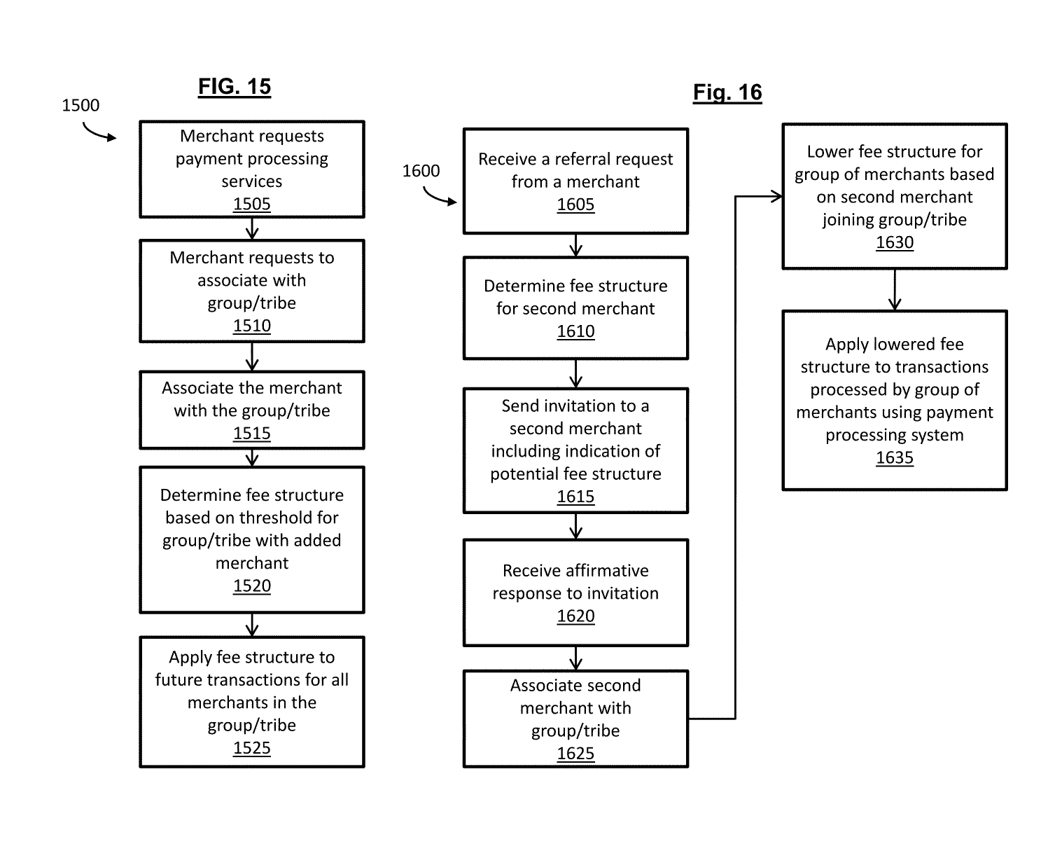

FIG. 15 is a flow diagram illustrating a method 1500 for joining a merchant group in accordance with an illustrative embodiment. In alternative embodiments, fewer, additional, and/or different operations may be performed. Also, the use of a flow diagram is not meant to be limiting with respect to the order of operations performed. In an operation 1505, a merchant request for payment processing services is made. In an operation 1510, the merchant requests to associate with (or join) a group of merchants (or a tribe). The requests represented by the operations 1505 and 1510 may be the same request or may constitute distinct actions by a merchant. In one example, these requests may occur when a merchant is signing up for a group and payment processing services using a web page or app such as the user interfaces 600 and 700 discussed above.

In an operation 1515, the payment processing system associates the merchant with the requested group or tribe. This may be done by a server of the payment processing system. In an alternative embodiment, the server that administrates the payments coops may be different from the server that administrates the payment processing system itself. In another embodiment, a hybrid system may occur: a payment processing system may only process transactions, while a payments coop server may administer the groups of merchants and administer the stored value accounts and loyalty/rewards programs for the groups of merchants. In yet another embodiment, a separate server or servers may be used to administrate stored value accounts and/or loyalty/rewards programs.

In an operation 1520, the system determines the fee structure based on a threshold met for the group of merchants as disclosed throughout the instant specification. The system determines the fee structure based on the addition of the new merchant being added to the group. In an operation 1525, the system applies the determined fee structure to future transactions executed by any of the group of merchants.

FIG. 16 is a flow diagram illustrating a method 1600 for sending a referral to a merchant in accordance with an illustrative embodiment. In alternative embodiments, fewer, additional, and/or different operations may be performed. Also, the use of a flow diagram is not meant to be limiting with respect to the order of operations performed. In an operation 1605, a system server receives a referral request from a merchant that is part of a group of merchants. The system determines what the fee structure would be for a second merchant that is the target of the referral request. For example, if the fee structure of a group of merchants would still apply to the group after the addition of the second merchant, than that original fee structure is the determined fee structure. In another example, the fee structure may be reduced if the second merchant joins the group. In that embodiment, the determined fee structure for the second merchant would be the reduced fee structure.

In an operation 1615, an invitation to join the group of merchants is sent to the second merchant. The invitation may contain various information, such as a message from the referring merchant, the determined fee structure, and instructions (and/or a link to any of the web pages discussed above with respect to FIGS. 2-14) to join the group of merchants. In an operation 1620, the system receives an affirmative response to the invitation. Such a response may, for example, be in the form of signing up for payment processing services and joining a group as described above with respect to FIGS. 6 and 7.

In an operation 1625, the system associates the second merchant with the group/tribe/network. That is, the second merchant has successfully joined the group of merchants. In an operation 1630, the system lowers the fee structure for the group of merchants based on the second merchant joining the group/tribe/network. In an alternative embodiment, the fee structure may not be reduced when some merchants join the group because a threshold has not been met. In an operation 1635, the system applies the lowered fee structure to transactions processed by the group of merchants using the payment processing system.

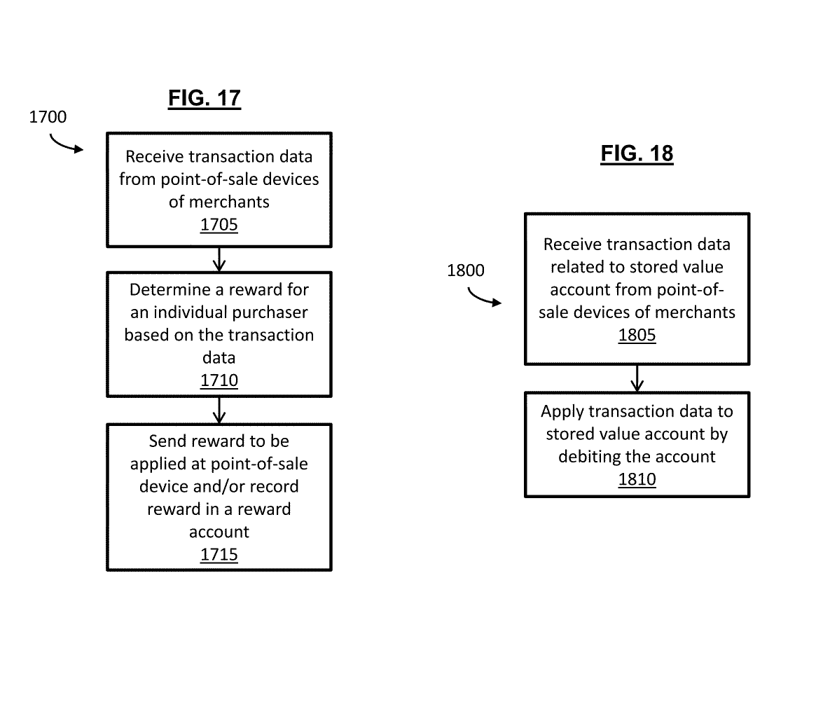

FIG. 17 is a flow diagram illustrating a method 1700 for a rewards program in accordance with an illustrative embodiment. In alternative embodiments, fewer, additional, and/or different operations may be performed. Also, the use of a flow diagram is not meant to be limiting with respect to the order of operations performed. In an operation 1705, the system receives transaction data from point-of-sale devices of merchants that are part of a group of merchants.

In an operation 1710, the system determines a reward for an individual purchaser based on the transaction data. That is, the system can figure out the identity of a customer of the merchant's in order to give that customer a reward for shopping with the merchant. In an operation 1715, the system sends the determined award to be applied at the point-of-sale device and/or records the reward in a reward account associated with the individual customer.

FIG. 18 is a flow diagram illustrating a method 1800 for a stored value account in accordance with an illustrative embodiment. In alternative embodiments, fewer, additional, and/or different operations may be performed. Also, the use of a flow diagram is not meant to be limiting with respect to the order of operations performed. In an operation 1805, the system receives transaction data related to a stored value account from a point-of-sale device of a merchant in a group of merchants. That is, part of the transaction data identifies a transaction amount and a stored value account to use for paying for the good or service. In an operation 1810, the system applies the transaction data (of at least the transaction amount) to the stored value account by debiting the account by the transaction amount.

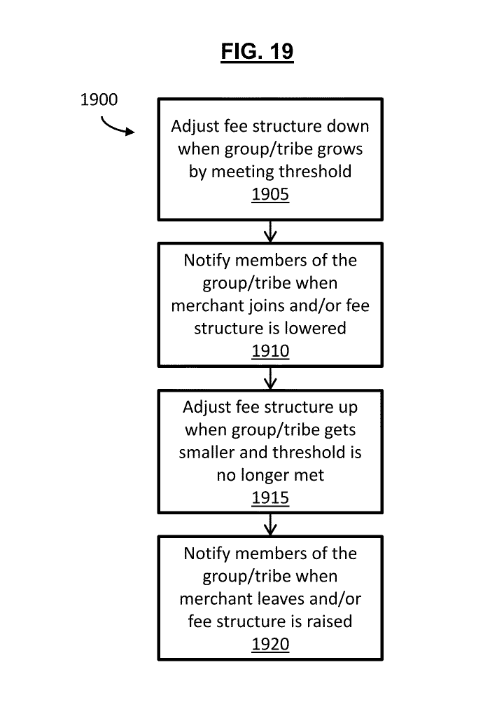

FIG. 19 is a flow diagram illustrating a method 1900 for a notification process for a group of merchants in accordance with an illustrative embodiment. In alternative embodiments, fewer, additional, and/or different operations may be performed. Also, the use of a flow diagram is not meant to be limiting with respect to the order of operations performed. In an operation 1905, the system adjusts a fee structure down when a group/tribe grows and meets a threshold.

In an operation 1910, the system notifies the members of a group of merchants whenever an additional merchant joins their group and/or whenever the group of merchants fee structure is lowered. (These two events may happen concurrently, or a merchant may join without a fee structure being lowered according to various embodiments as disclosed herein.) In an operation 1915, the system adjusts a fee structure up when a group of merchants gets smaller and no longer meets a threshold. In an operation 1920, the system notifies the members whenever a merchant leaves the group of merchants and/or whenever the fee structure is raised. (As with the operation 1910, a merchant may leave without causing the fee structure to raise. However, the other merchants may still be notified of the departure.)

In an illustrative embodiment, any of the operations described herein can be implemented at least in part as computer-readable instructions stored on a computer-readable medium or memory. Upon execution of the computer-readable instructions by a processor, the computer-readable instructions can cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method according to a set of instructions stored on the memory of a computing device, the method comprising:
receiving, by a processor of the computing device, a request from a merchant device for payment processing services, wherein the merchant device is associated with a first merchant;
receiving, by the processor, a request from the merchant device to associate with a group of merchants;
associating, by the processor, the merchant with the group of merchants such that the merchant is considered a part of the group of merchants;
determining, by the processor, a fee structure for the payment processing services for the merchant, wherein the fee structure is determined based on a threshold met by the group of merchants.

2. The method of claim 1, further comprising applying, by the processor, the fee structure to transactions performed by the merchant using the payment processing service.

3. The method of claim 2, further comprising applying, by the processor, the fee structure to transactions performed by all of the group merchants using the payment processing service.

4. The method of claim 3, wherein when the group of merchants meets the threshold, the fee structure for the payment processing service for the group of merchants is reduced.

5. The method of claim 2, wherein the fee structure is applied to the transactions at a point-of-sale system associated with the merchant.

6. The method of claim 1, wherein the threshold is a total number of merchants in the group of merchants.

7. The method of claim 1, wherein the threshold is a number of transactions processed by the group of merchants using the payment processing services during a predetermined amount of time.

8. The method of claim 1, wherein the threshold is a cumulative amount of transactions processed by the group of merchants using the payment processing services during a predetermined amount of time.

9. The method of claim 1, further comprising:
receiving, by the processor, a referral request from the merchant device, wherein the referral request comprises contact information for a second merchant; and
sending to a second merchant device using the contact information, by the processor, an invitation comprising a request to associate with the group of merchants and use the payment processing services, wherein the second merchant device is associated with the second merchant, and further wherein the second merchant is not associated with the group of merchants when the invitation is sent.

10. The method of claim 9, further comprising:
determining, by the processor, a potential fee structure for the payment processing services for the merchant and a second merchant associated with a second merchant device, wherein the fee structure is determined based on a threshold met by the group of merchants and the second merchant is considered a part of the group of merchants, and further wherein the invitation further comprises:
an identification of the merchant from which the referral request originated,
instructions on how to associate with the group of merchants and use the payment processing services, and
an indication of the fee structure that would apply to the payment processing services if the invitation to use the payment processing services and the invitation to associate with the group of merchants are accepted.

11. The method of claim 9, further comprising:
receiving, by the processor, an affirmative response to the invitation from the second merchant device; and
associating, by the processor, the second merchant with the group of merchants such that the second merchant is considered a part of the group of merchants.

12. The method of claim 11, further comprising:
determining, by the processor, based on the addition of the second merchant to the group of merchants, that the fee structure for the payment processing services is lowered based on the group of merchants meeting a second threshold; and
applying, by the processor, a lowered fee structure to all merchants in the group of merchants in response to determining that the group of merchants met the second threshold.

13. The method of claim 1, wherein the request from a merchant device for payment processing services and the request from the merchant device to associate with a group of merchants are included in a single request.

14. A non-transitory computer readable medium having instructions stored thereon that, upon execution by a computing device, cause the computing device to perform operations, wherein the instructions comprise:
instructions to receive a request from a merchant device for payment processing services, wherein the merchant device is associated with a first merchant;
instructions to receive a request from the merchant device to associate with a group of merchants;
instructions to associate the merchant with the group of merchants such that the merchant is considered a part of the group of merchants;
instructions to determine a fee structure for the payment processing services for the merchant, wherein the fee structure is determined based on a threshold met by the group of merchants.

15. The non-transitory computer readable medium of claim 14, further comprising:
instructions to receive transaction data from point-of-sale devices associated with any of the group of merchants, wherein the transaction data comprises individual purchaser payment and identity data and purchase amount data; and
instructions to determine rewards for individual purchasers based on the transaction data.

16. The non-transitory computer readable medium of claim 14, further comprising:
instructions to receive transaction data from point-of-sale devices associated with any of the group of merchants, wherein the transaction data comprises a stored value account identifier and purchase amount data; and
instructions to debit a stored value account associated with the stored value account identifier, wherein the stored value account is debited based on the purchase amount data.

17. The non-transitory computer readable medium of claim 14, further comprising:
instructions to determine the fee structure each time an additional merchant device associated with an additional merchant requests to be associated with the group of merchants, wherein the fee structure is decreased;
instructions to determine the fee structure each time an existing merchant device associated with an existing merchant already associated with the group of merchants requests to cease being associated with the group of merchants, wherein the fee structure is increased; and
instructions to notify each of a plurality of merchant devices associated with the group of merchants in response to each time the fee structure is determined.

18. An apparatus comprising:
a memory;
a processor coupled to the memory; and
a first set of instructions stored on the memory and configured to be executed by the processor, wherein the processor is configured to:
receive a request from a merchant device for payment processing services, wherein the merchant device is associated with a first merchant;
receive a request from the merchant device to associate with a group of merchants;
associate the merchant with the group of merchants such that the merchant is considered a part of the group of merchants;
determine a fee structure for the payment processing services for the merchant, wherein the fee structure is determined based on a threshold met by the group of merchants.

19. The apparatus of claim 18, wherein the group of merchants are in a similar geographic area, provide a similar product or service, or engage in commerce in a similar format.

20. The apparatus of claim 19, wherein the processor is further configured to send, to a display of a graphical user interface on the merchant device, an indication of the group of merchants comprising a number of merchants in the group of merchants, the identities of merchants in the group of merchants, and an indication of referred merchants that have joined the group of merchants as a result of a referral request of the first merchant.
